(19) United States
(12) Patent Application Publication
(10) Pub. No.: US 2005/0198562 A1
(43) Pub. Date: Sep. 8, 2005

(54) System and method for customizing shipping labels

(76) Inventors: Charles Bravo, Fairfax, VA (US); Vantresa S. Stickler, Annapolis, MD (US)

Correspondence Address: FINNEGAN, HENDERSON, FARABOW,;GARRETT & DUNNER, L.L.P., 1300 I Street, N.W., Washington, DC, 20005, US

(21) Appl. No.: 10/953,265

(22) Filed: Sep. 30, 2004

Related U.S. Application Data
(60) Provisional application No. 60/539,349, filed on Jan. 28, 2004.

(51) Int. Cl. G06F 17/00

(52) U.S. Cl. 715/505; 715/843; 715/764; 715/507

(57) ABSTRACT

Systems and method for customizing a shipping label allow users to select among a list of personalized endorsements which may be displayed on a shipping label printed by the user from an Internet website. The user may also create a personalized endorsement. The personalized endorsement or message appears in a white space of the shipping label, which may contain other information regarding contact and confirmation information.

### RELATED APPLICATIONS

This application is related to and claims priority of U.S. Provisional Application No. 60/539,349 entitled “System and Method for Customizing Shipping Labels” filed Jan. 28, 2004, which is incorporated herein by reference in its entirety.

### TECHNICAL FIELD

This invention relates generally to a system and method for customizing labels, and more particularly, to a system and method for providing personalized or non-utilitarian messages or endorsements on shipping labels used to deliver mail packages.

### BACKGROUND

Presently, users desiring to ship or mail packages can affix labels onto a package, wherein the shipping labels may be printed from the user's personal computer using an on-line service. To prepare the label, the user may enter information regarding the return address and destination address into fields on an Internet webpage and print out a shipping label containing entered information. The user may also pay the shipping cost using a web payment system. The shipping labels may contain information that allows a shipping service provider, e.g., the United States Postal Service (USPS), to accurately and efficiently deliver the package associated with the shipping label. The shipping label contains information including the destination address and the amount of shipping cost paid to deliver the package. This information may be displayed in the form of a barcode that allows mail carriers to scan or input the information in an efficient manner. Using an on-line service to simply click on information relevant to the shipping information and print out an associated shipping label saves the user time and money as opposed to, for example, a process involving the user visiting and delivering packages to a service provider facility.

While it is known to provide personalized messages on invoices within a package, for example when a package is purchased from a catalog or online, the personalized message cannot be viewed by the recipient until the package is opened. A sender not wanting the recipient to receive an invoice, for example if the package contains a gift, cannot then send his personalized message. It is also known to include cards bearing a personalized greeting in a package, which has the above-stated drawback that the personalized message cannot be viewed by the recipient until the package is opened.

It is desirable to add personalized notes, greetings, messages, or endorsements to the exterior of the package, so that the recipient receives the personal message upon receipt of the package and upon viewing the sender's name. For example, if the user is sending a birthday present to another person, the user may desire to have the shipping label read, “Happy Birthday,” in addition to the other contact information.

It is therefore desirable to provide a system and method that allows users to print out shipping labels for packages that include personalized labels having a message catered to the recipient.

### SUMMARY

In accordance with an embodiment of the invention, a system for printing a customized shipping label to be placed on a piece of mail comprises an input screen having input fields, the input fields including a field for entry of a personalized endorsement that appears on the shipping label.

In accordance with another embodiment of the invention, a method for printing a customized shipping label to be placed on a piece of mail comprises the step of inputting a personalized endorsement that appears on the shipping label.

In accordance with another embodiment of the invention, a method of printing a customized shipping label to be placed on a piece of mail comprises the steps of accessing an internet website that facilitates printing of shipping labels, accessing the website's screen for inputting shipping label information, inputting shipping information, inputting a personalized endorsement that appears on the shipping label, submitting the entered information, and printing the label.

In accordance with yet another embodiment of the invention, a system for printing a customized shipping label comprises an internet website that facilitates printing of shipping labels, a screen on the website for inputting shipping label information, a field on the screen for entering a personalized endorsement that appears on the shipping label, wherein the system formats a shipping label from the entered information and prints the shipping label, including the personalized endorsement, to a local printer.

It is to be understood that both the foregoing general description and the following detailed description are exemplary and explanatory only and are not restrictive of the appended claims.

The accompanying drawings, which are incorporated in and constitute a part of this specification, illustrate one embodiment and together with the description, serve to explain the principles of the invention.

### BRIEF DESCRIPTION OF THE DRAWINGS

FIG. 1 is a flowchart illustrating a method consistent with an embodiment of the invention for customizing a shipping label.

FIG. 2 is an illustration of a computer display consistent with an embodiment of the invention for customizing a shipping label.

FIG. 3 is another illustration of a computer display consistent with an embodiment of the invention for customizing a shipping label.

FIG. 4 is yet another illustration of a computer display consistent with an embodiment of the invention for customizing a shipping label.

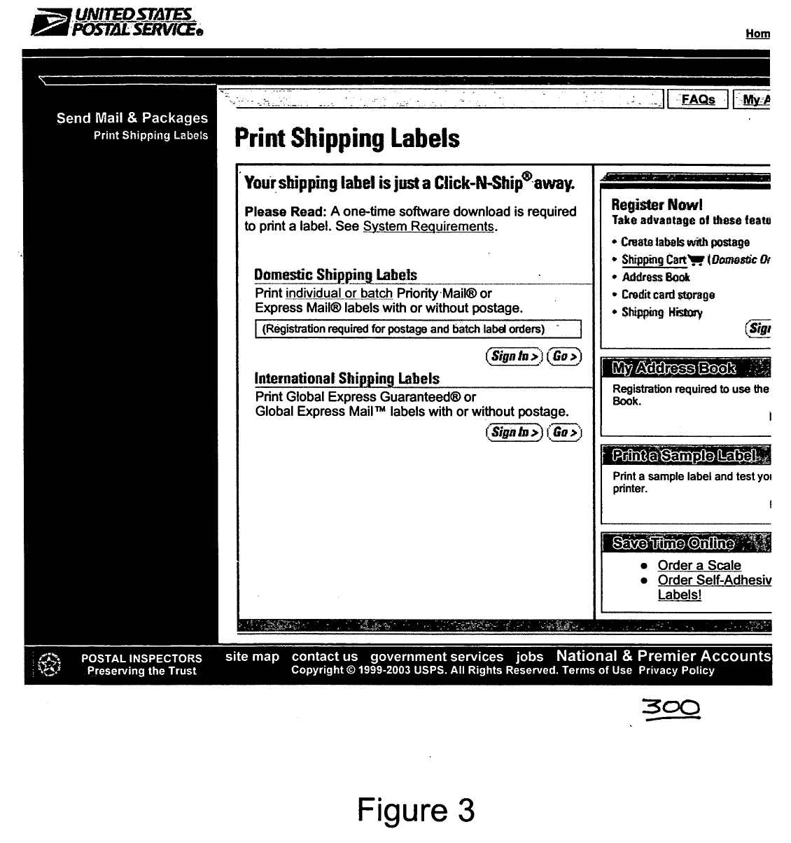

FIG. 3 is an illustration of a customized shipping label consistent with an embodiment of the invention.

### DESCRIPTION OF THE EMBODIMENTS

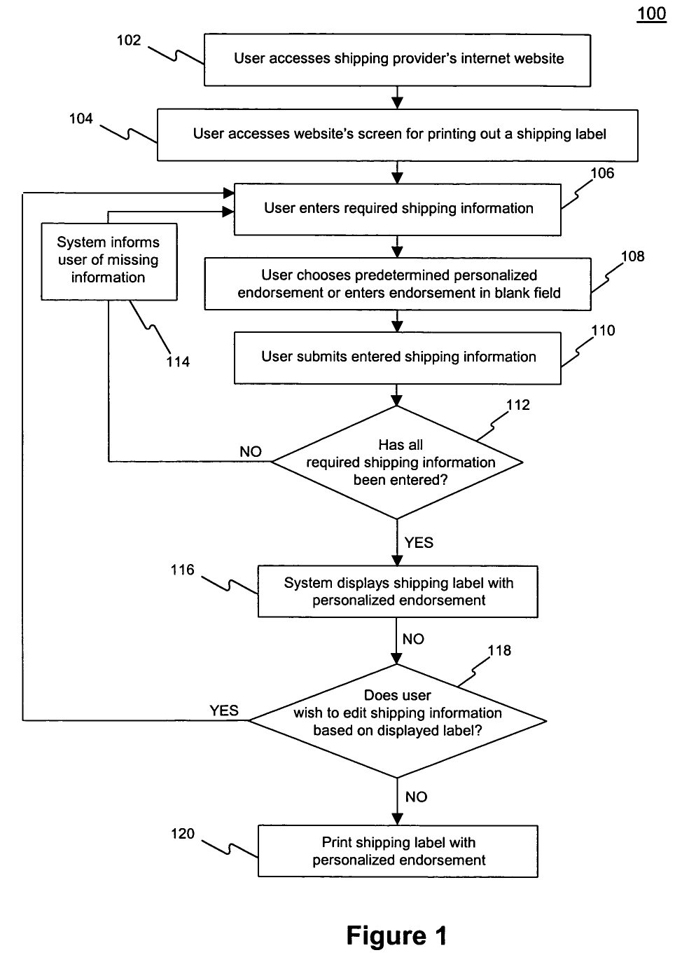

Referring now to the drawings, in which the same reference numbers will be used throughout the drawings to refer to the same or like parts, FIG. 1 is a flowchart 100 showing the tasks and steps for customizing a shipping label by providing a personalized endorsement.

Flowchart 100 begins at stage 102 when a user accesses a shipping provider's Internet website for printing shipping labels to deliver a package to a destination. At stage 104, the user accesses the website's screen for printing out a shipping label. That screen includes entry fields, into which the user enters information for the delivery of the package, such as the sender's and recipient's address information. Among the entry fields, there may be a drop-down menu listing predetermined personalized endorsements that can be added to the shipping label. As used herein, a personalized endorsement is information that may be unrelated to the functional information used for delivery of the package.

At stage 106, the user enters shipping information into the entry fields. At stage 108, the user may select one of the predetermined personalized endorsements from the list to be displayed on the shipping label. In an alternative embodiment of the invention, the user types in a personalized endorsement instead of selecting from predetermined endorsements listed in a drop-down menu. Other methods of inputting the personal endorsement may include pasting text or such similar methods of entry as inserting or importing characters from a file, or even voice recognition. At stage 1 10, the user submits the entered shipping information. The system determines whether all of the required shipping information has been entered at stage 112.

If the user has not entered all of the required shipping information, the system informs the user of the missing information at stage 114, preferably pointing out the exact missing fields, and again displays the entry fields for inputting the shipping information at stage 106. If, however, the user has entered all of the required shipping information, the shipping label is displayed to the user at stage 116. Stage 118 illustrates that if, after viewing the label, the user wishes to edit the shipping information, including changes to the personalized endorsement, the system again displays the entry fields for inputting the shipping information at stage 106. Once the user is satisfied with the shipping label, the user may print out the shipping label (stage 120) which contains the personalized endorsement and other information to be used by the service provider in delivering the package. The label is preferably printed on the user's local or network printer, but can alternatively be printed and shipped to the user. Prior to printing the label, the user preferably enters payment information.

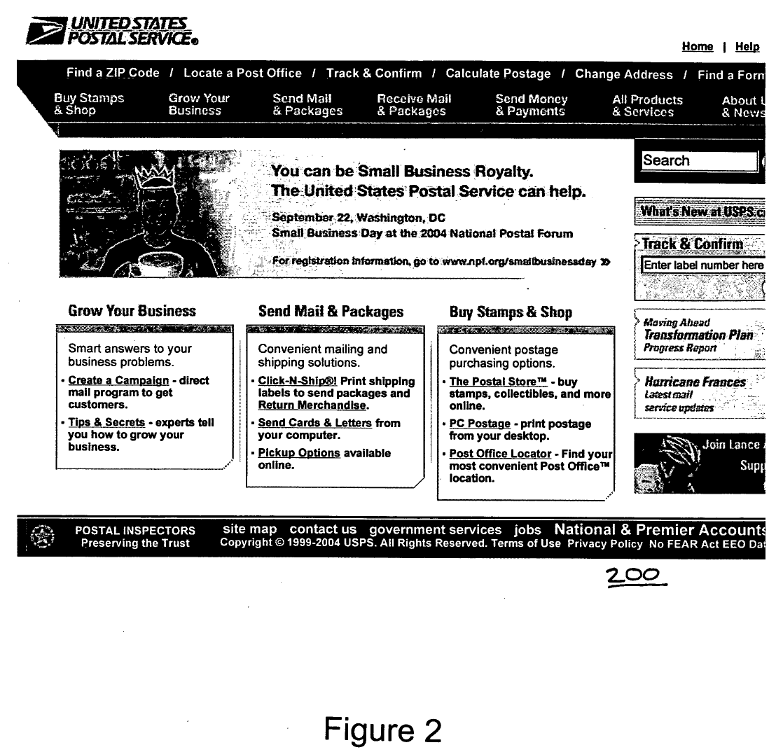

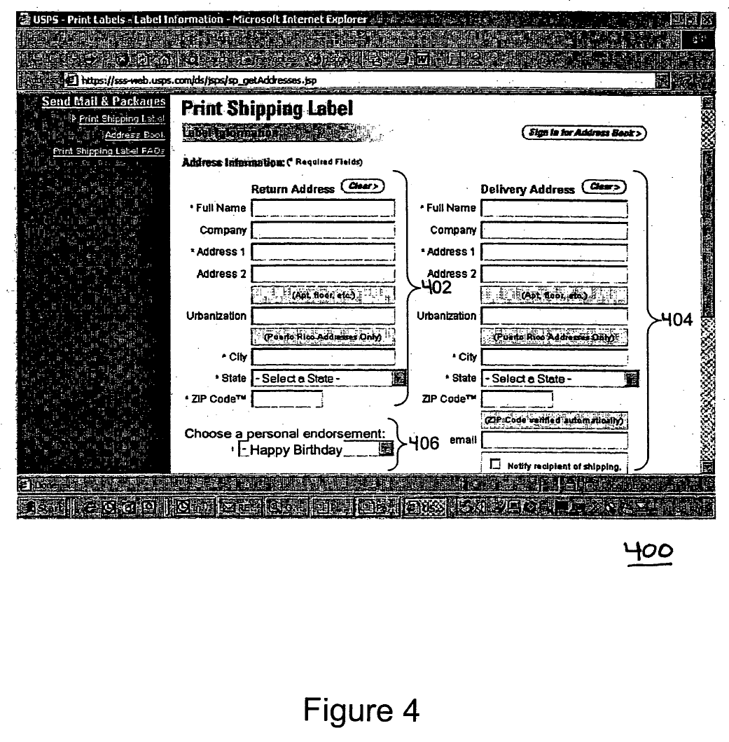

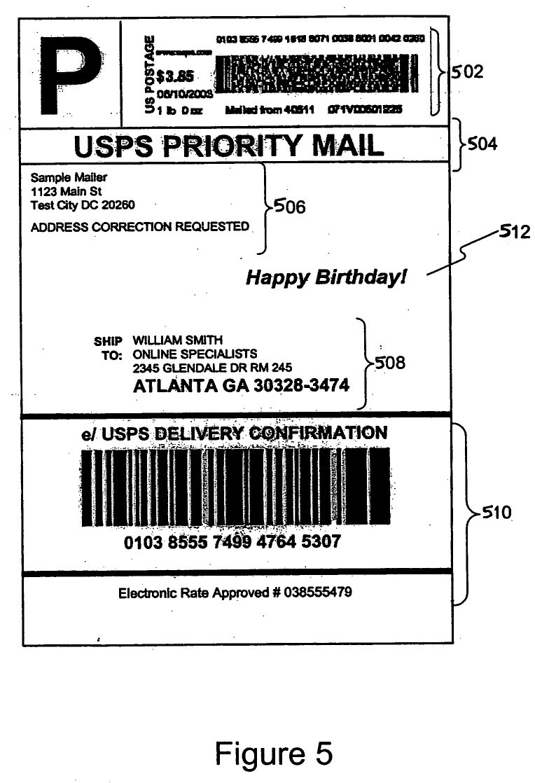

FIG. 2 illustrates a screen or display 200 of an embodiment of the invention. This screen is preferably accessed when the user logs into a shipping provider's Internet website. From this exemplary screen, the user can choose to print a shipping label by clicking on Click-N-Ship®!. This action preferably brings the user to exemplary screen or display 300 of FIG. 3. On this screen, the user can choose between printing Domestic Shipping Labels and International Shipping Labels. If the user chooses to print Domestic Shipping Labels, he or she is preferably taken to another exemplary screen 400 as shown in FIG. 4 to enter certain relevant shipping information. In a preferred embodiment of the invention, at this point the user may choose to sign in with his or her ID and password, for example by pressing “Sign In,” and access saved settings in the system such as his or her return address and a stored list of destination addresses. Otherwise, the user can press “Go” and bypass signing in.

FIG. 4 illustrates an embodiment of the screen or display 400 for entering shipping information and customizing a shipping label. Screen 400 contains fields 402 for entering return address information, fields 404 for entering delivery address information, and a personalized endorsement menu 406. This screen may also include entry fields for other relevant shipping information such as package weight, package size, type of service (e.g., Delivery Confirmation, Priority Mail, Signature Confirmation, Express Mail), and the user's email address if the user desires to be notified via email of shipping.

In fields 402, the user may enter return address information, which may include the sender's name, company, street address, apartment or floor number, city, state, and ZIP code. In fields 404, the user enters the destination or delivery address information, which may include a recipient's name, company, street address, apartment or floor, city, state, ZIP code, and email.

In an embodiment of the invention, the user may also select a personalized endorsement using endorsement menu 406, which is a drop-down menu allowing the user to choose among predetermined endorsements. For example, endorsement menu 406 shows that the message “Happy Birthday” has been selected. Other messages that may be chosen include, for example, “Thinking of You,” “Merry Christmas,” “Happy Hanukah,” “Happy Father's Day,” “Happy Mother's Day,” “Congratulations,” “Happy Holidays,” and “Happy Valentine's Day.” The predetermined endorsements then appear on the shipping label. The user may also have the option of selecting and editing the color and font type. Alternatively, the user may create a unique message (field not illustrated) to serve as the personalized endorsement, with choices in the content, color, and font type.

Once the user has entered return address information in fields 402, has entered delivery address information in fields 404, and has selected or entered a personal endorsement, the user submits the entered information, preferably by hitting the enter key or clicking on a button labeled, for example, “Continue,” “Ship,” or “Submit.” The user may be directed to another screen that asks the user to confirm the accuracy of the information submitted in screen 400 or to enter additional information. If the user desires to edit the entered information, the user may be directed back to screen 400 to re-submit information into fields 402, 404 or menu 406. If the user is satisfied with information submitted, the user may enter a command to print a shipping label containing the information submitted in screen 400 as well as other information to be used by a service provider.

Further, if the user has not entered information that is necessary for shipping, the system may direct the user back to screen 400 to enter the missing information. If this redirect is necessary, the system preferably identifies the missing information to the user.

In a preferred embodiment of the invention, if the user chooses to print International Shipping labels, he or she is taken to a screen similar to that in FIG. 4, but which requires input of additional information needed for international shipments.

FIG. 5 is an illustration of an embodiment of a shipping label 500 produced by a system and method consistent with the invention. It includes a personalized endorsement. Shipping label 500 preferably includes shipping information 502, a shipping designator setting forth the type of service 504, a return address 506, a delivery address 508, delivery confirmation information 510, and a personalized endorsement 512.

Shipping information 502 contains information for the service provider to aid in processing the package for shipment. Shipping information 502 may include a date of shipment, weight of the package, shipping cost paid, ZIP code where the label was printed, time of label printing, address information, and tracking information.

Shipping designator 504 is a designation of the type of shipping service being provided. For example, shipping designator 504 may be Delivery Confirmation, Priority Mail, Signature Confirmation, Express Mail, Global Priority, Global Priority Guaranteed, Parcel Post, or an Intelligent Mail product or service such as CONFIRM.

Return address 506 contains information of the user or sender, and preferably includes the information that the user entered into return address information fields 402 in FIG. 4.

Delivery address 508 contains contact information for the recipient, and preferably includes the information entered into delivery address information fields 404 in FIG. 4.

Delivery confirmation information 510 is a tracking code that may be used by a service provider to determine a delivery status of the package containing shipping label 502. Delivery confirmation information 510 contains information such as a delivery ZIP code and/or a unique tracking ID.

Personal endorsement 512 is the endorsement selected or entered by the user to appear on the shipping label. Its purpose is to provide the recipient with a greeting upon receiving the delivered package, before the package is opened. Personalized endorsement 512 preferably appears above the recipient's name or in other white space of shipping label 500, and includes the endorsement as entered into personalized endorsement menu 406 in FIG. 4.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for printing a customized shipping label to be placed on a piece of mail, comprising an input screen having input fields, the input fields including a field for entry of a personalized endorsement that appears on the shipping label.

2. The system of claim 1, wherein the system is accessed via the internet and the label is printed on a local printer.

3. The system of claim 1, wherein the field for entry of a personalized endorsement is a drop-down menu.

4. The system of claim 1, wherein the field for entry of a personalized endorsement is a blank field into which a personal endorsement is typed or similarly input.

5. A method for printing a customized shipping label to be placed on a piece of mail, said method comprising the step of inputting a personalized endorsement that appears on the shipping label.

6. The method of claim 5, wherein a system for printing the label is accessed via the internet and the shipping label is printed on a local printer.

7. The method of claim 5, wherein the step of inputting a personalized endorsement includes choosing a personalized endorsement from a drop-down menu.

8. The method of claim 5, wherein the step of inputting a personalized endorsement includes typing or similarly inputting the personalized endorsement.

9. A method of printing a customized shipping label to be placed on a piece of mail, comprising the steps of:
accessing an internet website that facilitates printing of shipping labels;
accessing the website's screen for inputting shipping label information;
inputting shipping information;
inputting a personalized endorsement that appears on the shipping label;
submitting the entered information; and
printing the label.

10. The method of claim 9, wherein the step of inputting a personalized endorsement includes choosing a personalized endorsement from a drop-down menu.

11. The method of claim 9, wherein the step of inputting a personalized endorsement includes typing or similarly inputting the personalized endorsement.

12. The method of claim 9, further including the step of displaying shipping information for verification prior to printing the shipping label.

13. The method of claim 9, further including the step of verifying that any required shipping information has been entered prior to printing the shipping label.

14. The method of claim 9, further including the step of submitting payment for shipment prior to printing the shipping label.

15. A system for printing a customized shipping label, comprising:
an internet website that facilitates printing of shipping labels;
a screen on the website for inputting shipping label information;
a field on the screen for entering a personalized endorsement that appears on the shipping label;
wherein the system formats a shipping label from the entered information and prints the shipping label, including the personalized endorsement, to a local printer.

16. The system of claim 15, wherein the field for entry of a personalized endorsement is a drop-down menu.

17. The system of claim 15, wherein the field for entry of a personalized endorsement is a blank field into which a personal endorsement is typed or similarly input.

18. The system of claim 15, wherein the shipping label is displayed for user verification prior to printing the shipping label.

19. The system, of claim 15, wherein the system verifies that any required shipping information has been entered prior to printing the shipping label.

20. The system of claim 15, wherein payment is submitted prior to printing the shipping label.
